(19) United States
(12) Patent Application Publication
(10) Pub. No.: US 2024/0129322 A1
(43) Pub. Date: Apr. 18, 2024

(54) SYSTEM AND METHOD FOR DETECTING DIGITAL INTRUSION AND REDIRECTING TO SAFE ZONE IN REAL-TIME

(71) Applicants: MICHAEL KOTLARZ, Short Hills, NJ (US); NAGABHUSHAN RAO MACHIRAJU, Goleta, CA (US); KEITH BARKSDALE, Hoboken, NJ (US)

(72) Inventors: MICHAEL KOTLARZ, Short Hills, NJ (US); NAGABHUSHAN RAO MACHIRAJU, Goleta, CA (US); KEITH BARKSDALE, Hoboken, NJ (US)

(21) Appl. No.: 17/968,102

(22) Filed: Oct. 18, 2022

(51) Int. Cl. H04L 9/40

(52) U.S. Cl. CPC H04L 63/1416; H04L 63/1466; H04L 63/20

(57) ABSTRACT

A system for detecting digital intrusion in real-time and redirecting to a safe zone, comprising of a pulse intrusion detection module comprising pulse injector constructs micro pulses and corresponding values into pulse and pulses is injected into content; documents; and communications. Pulse reader validates pulse of valid user; identifies unauthorized users and detects pulse intrusion during injection of the pulse into content; unauthorized attempt to read pulse-protected document, unauthorized attempt to log into pulse-protected communication. Pulse reader detects unauthorized users trying to attempt to access pulse-protected content; pulse-protected document; and pulse-protected communication upon determining micro pulses and corresponding values are not valid and are on bad actor/threat list. Pulse oracle changes micro pulses and corresponding values continuously and programmatically to mitigate and eliminate brute-force attacks, and to generate and archive forensic evidence. Pulse oracle re-directs unauthorized user to safe zone to spoof authentication process for gathering additional intelligence.

### COPYRIGHT AND TRADEMARK NOTICE

This application includes material which is subject or may be subject to copyright and/or trademark protection. The copyright and trademark owner(s) has no objection to the facsimile reproduction by any of the patent disclosure, as it appears in the Patent and Trademark Office files or records, but otherwise reserves all copyright and trademark rights whatsoever.

### TECHNICAL FIELD

The disclosed subject matter relates generally to communication systems. More particularly, the present disclosure relates to a computer-implemented system and method for detecting digital intrusion and redirecting to a safe zone to spoof a real-time authentication process, thereby refusing an unauthorized user attempting to access communications, data, content, or documents that they do not have permission to view.

### BACKGROUND

Generally, the internet is a global system of interconnected computer networks comprising private, public, academic, business, and government networks of local to global scope, linked by a broad array of electronic, wireless, and optical networking technologies. The internet carries a vast range of information resources and services and is critical to the world's communications infrastructure. However, the internet also represents an insecure channel for exchanging information leading to a high risk of digital intrusion or fraud. As such, individual users and enterprises need to utilize some form of internet security to decrease the risk of data breaches due to such threats.

Malicious actors on the internet often try to fool users into thinking they are interacting with known, trusted entities. For example, one common threat is a phishing attack, which is a criminal fraud procedure that attempts to obtain sensitive personal information, such as login credentials (i.e., usernames, passwords, PINs, etc.), personal details (i.e., name, address, phone number(s), email address(es), etc.) and payment information (i.e., credit card details, electronic payment information, bank account numbers, etc.) by using electronic communications disguised as legitimate and trustworthy content. The existing systems help identify the malicious attacks and fraudulent web documents and issue alerts to the user. However, the current systems fail to refuse access to personal content/data and communications. The existing system fails to identify the attacker's information, intent, and origin. Hence, there is a need to develop a system for detecting digital intrusion and redirecting the attackers to a safe zone (reverse phishing area) to spoof an authentication process in real-time to gather additional intelligence about the attacker and their intentions, thereby refusing access to the user content, document, and communications.

In the light of the aforementioned discussion, there exists a need for a particular system with novel methodologies that would overcome the above-mentioned challenges.

### SUMMARY

The following invention presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

An objective of the present disclosure is directed towards a system for detecting continual digital intrusion and redirecting to a safe zone to spoof an authentication process in real-time.

Another objective of the present disclosure is directed towards the system that refuses unauthorized users trying to access communications, data, or content they do not have permission to view.

Another objective of the present disclosure is directed towards the system that identifies the unauthorized user attempt and re-directs the unauthorized user to the safe zone to spoof the authentication process to gather additional intelligence about the attacker and their intentions.

Another objective of the present disclosure is directed towards the system that aggregates more data about the unauthorized user, their intent, and their origin.

Another objective of the present disclosure is directed towards the system that delivers data prompts to the second computing device upon detecting the unauthorized user is in the safe zone.

Another objective of the present disclosure is directed towards the system that enables the unauthorized user to provide additional intelligence as input which helps in identifying, whom the unauthorized user is attempting to impersonate, what unauthorized user is trying to steal, or what malicious activity the unauthorized user attempt to perform.

Another objective of the present disclosure is directed towards the system that enables the data prompts to work as a typical phishing attack but in reverse, where the pulse intrusion detection module extracts responses and data from the unauthorized user for use in forensic analysis.

According to an exemplary aspect of the present disclosure, a system for detecting digital intrusion in real-time and redirecting to a safe zone includes a first and third computing device.

According to an exemplary aspect of the present disclosure, the first and third computing devices. The first and third devices includes a processor, memory and a pulse intrusion detection module. The processor, coupled with the memory configured to store a pulse intrusion detection module.

According to another exemplary aspect of the present disclosure, the pulse intrusion detection module includes a pulse injector, a pulse reader, a pulse oracle, and a pulse data manager, the pulse injector is configured to construct a set of micro pulses and corresponding values into a pulse and the pulse is injected into at least one of: content; document; and communication thereby creating at least one of: a pulse protected content; a pulse-protected document; and a pulse-protected communication.

According to another exemplary aspect of the present disclosure, the pulse reader is configured to remain in synchronization with the pulse injector, and the pulse reader is configured to validate the pulse of at least one valid user; and identify an unauthorized user; who attempts to access at least one of the pulse-protected items; the pulse-protected document; and the pulse-protected communication; and detects digital intrusion during at least one of an injection of the pulse into the content by the unauthorized user on the second computing device; an unauthorized attempt by the unauthorized user on the second computing device to read the pulse-protected document located on the at least of the first computing device; and the third computing device; and the unauthorized attempt by the unauthorized user on the second computing device to login into the pulse-protected communication established between the first computing device; and the third computing device.

According to another exemplary aspect of the present disclosure, the pulse reader is configured to determine at least one of the set of micro pulses and corresponding values injected into at least one of the pulse-protected content; the pulse-protected document; and the pulse-protected communication are valid, and the set of micro pulses and corresponding values are on a bad actor/threat list.

According to another exemplary aspect of the present disclosure, the pulse reader is configured to detect the unauthorized user on the second computing device trying to attempt to access at least one of the pulse-protected content; the pulse-protected document; and the pulse-protected communication; upon determining the set of micro pulses and corresponding values are not valid, and the set of micro pulses and corresponding values are on the bad actor/threat list.

According to another exemplary aspect of the present disclosure, the pulse oracle through its synchronization with the pulse-reader, and the pulse-injector configured to change the set of micro pulses and corresponding values continuously and programmatically to mitigate and eliminate the value of brute-force attacks, and to generate and archive forensic evidence about at least one of: the pulse-protected content; the pulse-protected document; and the pulse-protected communication upon identifying at least one of: the pulse-protected content; the pulse-protected document and the pulse-protected communication are at risk.

According to another exemplary aspect of the present disclosure, the pulse oracle is configured to re-direct the unauthorized user to a safe zone to spoof the authentication process for gathering additional intelligence and refuses to access at least one of: the pulse-protected content; the pulse-protected document; and the pulse-protected communication.

### BRIEF DESCRIPTION OF THE DRAWINGS

In the following, numerous specific details are set forth to provide a thorough description of various embodiments. Certain embodiments may be practiced without these specific details or with some variations in detail. In some instances, certain features are described in less detail so as not to obscure other aspects. The level of detail associated with each of the elements or features should not be construed to qualify the novelty or importance of one feature over the others.

FIG. 1 is a block diagram depicting a schematic representation of a system for detecting digital intrusion and redirecting to safe zone in real-time, in accordance with one or more exemplary embodiments.

FIG. 2 is a block diagram depicting an embodiment of the pulse intrusion detection module 116, in accordance with one or more exemplary embodiments.

FIG. 3 is a block diagram depicting an embodiment of the digital intrusion detection, in accordance with one or more exemplary embodiments.

FIG. 4 is a flow diagram depicting a method for detecting digital intrusion at the injection of the pulse into content, in accordance with one or more exemplary embodiments.

FIG. 5 is a flow diagram depicting a method for detecting an unauthorized attempt to read the pulse-protected document, in accordance with one or more exemplary embodiments.

FIG. 6 is a flow diagram depicting a method for detecting an unauthorized attempt to log into the pulse-protected communication in accordance with one or more exemplary embodiments.

FIG. 7 is a flow diagram depicting a method for detecting digital intrusion and redirecting to safe zone to spoof authentication process in real-time, in accordance with one or more exemplary embodiments.

FIG. 8 is a block diagram illustrating the details of a digital processing system in which various aspects of the present disclosure are operative by execution of appropriate software instructions.

Furthermore, the objects and advantages of this invention will become apparent from the following description and the accompanying annexed drawings.

### DETAILED DESCRIPTION OF EXAMPLE EMBODIMENTS

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and so forth, herein do not denote any order, quantity, or importance, but rather are used to distinguish one element from another.

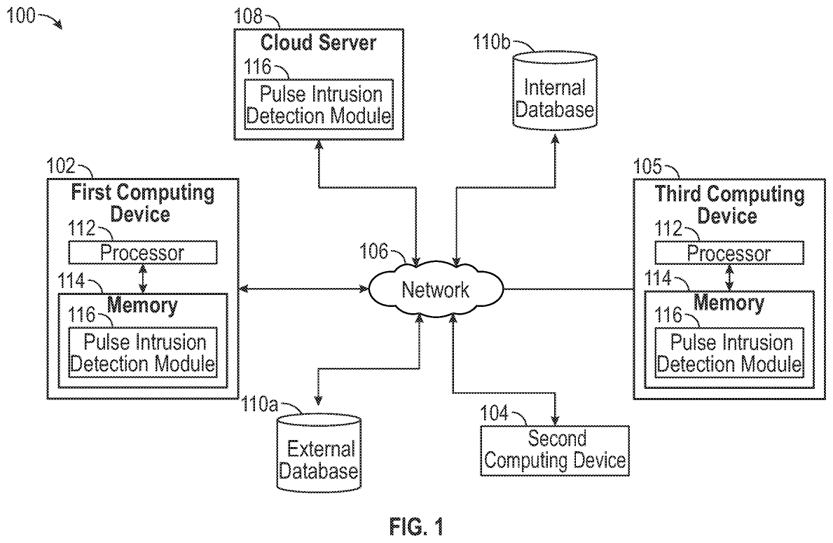

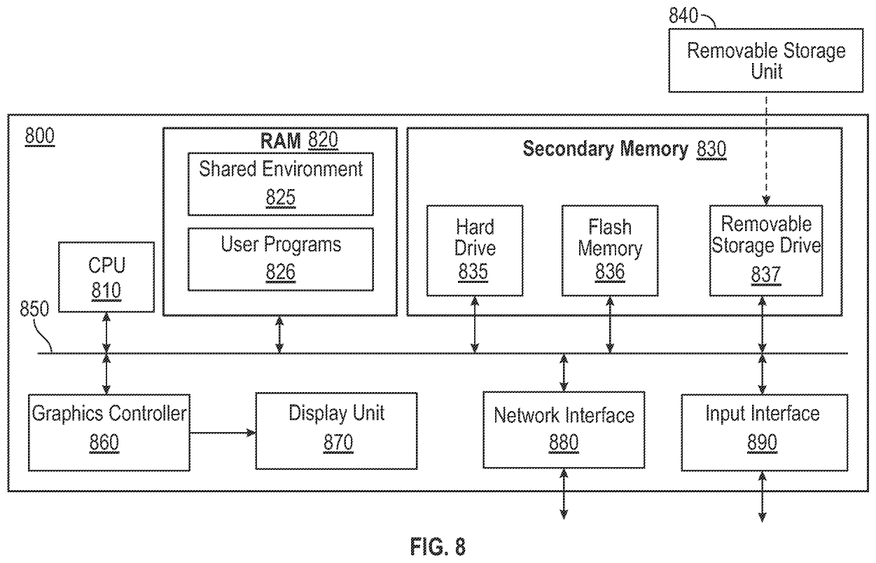

Referring to FIG. 1 is a block diagram 100 depicting a schematic representation of a system for detecting digital intrusion and redirecting to safe zone to spoof authentication process in real-time, in accordance with one or more exemplary embodiments. The system 100 may be a robust, dynamic, and undetectable security system/secure praxis. The system 100 includes a first computing device 102, a second computing device 104, a third computing device 105, a network 106, a cloud server 108, an external database 110a, and an internal database 110b. The first computing device 102 and the third computing device 105 include a processor 112, a memory 114, and a pulse intrusion detection module 116. The processor 112 includes the memory 114 may be configured to store the pulse intrusion detection module 116 on the first computing device 102 and the third computing device 105. The processor 104 may be a central processing unit and/or a graphics processing unit (As shown in FIG. 8). The first computing device 102, or the third computing device 105 may be connected to one or more computing devices over the network 106. The term “module” is used broadly herein and generally refers to a program resident in the memory of the first computing device 102 and third computing device 105.

The network 106 may include, but not limited to, an Internet of things (IoT network devices), an Ethernet, a wireless local area network (WLAN), or a wide area network (WAN), a Bluetooth low energy network, a ZigBee network, a WIFI communication network e.g., the wireless high speed internet, or a combination of networks, a cellular service such as a 4G (e.g., LTE, mobile WiMAX) or 5G cellular data service, a RFID module, a NFC module, wired cables, such as the world-wide-web based Internet, or other types of networks may include Transport Control Protocol/Internet Protocol (TCP/IP) or device addresses (e.g. network-based MAC addresses, or those provided in a proprietary networking protocol, such as Modbus TCP, or by using appropriate data feeds to obtain data from various web services, including retrieving XML data from an HTTP address, then traversing the XML for a particular node) and so forth without limiting the scope of the present disclosure. The network 106 may be configured to provide access to different types of users. The computing devices 102, 104, 105 may include, but is not limited to, a personal digital assistant, smartphones, personal computers, a mobile station, computing tablets, a handheld device, an internet-enabled calling device, an internet-enabled calling software, a telephone, a mobile phone, a digital processing system, a virtual machine, a cloud-hosted server, a docker container and so forth. The pulse intrusion detection module 116 is accessed as a mobile application, web application, and software that offers the functionality of accessing mobile applications and viewing/processing interactive pages.

The pulse intrusion detection module 116 on the first computing device 102, and/or the third computing device 105 is accessed as a mobile application, web application, software that offers the functionality of accessing mobile applications, and viewing/processing of interactive pages, for example, are implemented in the first computing device 102 or the third computing device 105, as will be apparent to one skilled in the relevant arts by reading the disclosure provided herein. For example, the pulse intrusion detection module 116 may be any suitable application downloaded from GOOGLE PLAY® (for Google Android devices), Apple Inc.'s APP STORE® (for Apple devices), or any other unified database, server, webpage, or uniform resource locator (URL). The pulse intrusion detection module 116 may be a desktop application that runs on Mac OS, Microsoft Windows, Linux, or any other operating system that may be downloaded from a webpage or a CD/USB stick and the like. In some embodiments, the pulse intrusion detection module 116 may be software, firmware, or hardware integrated into the first computing device 102, and/or the third computing device 105.

Although the first computing device 102 or second computing device 104, the third computing device 105 is shown in FIG. 1A, an embodiment of the system 100, may support any number of computing devices. The first computing device 102 or second computing device 104, and the third computing device 105 may be operated by the users or programmatically via pre-configured application logic. The first computing device 102 or second computing device 104, third computing device 105 supported by the system 100 is realized as a computer-implemented or computer-based device having the hardware or firmware, software, and/or processing logic needed to carry out the computer-implemented methodologies described in more detail herein. The first computing device 102 and the third computing device 105 may be operated by a valid user. The valid user may include, but is not limited to, a creator, an admin, an individual, a host, a sender, an authentic user, a participant, a member, an observer, an authorized user, a certified user, content receivers, friends, family, neighbors, and the like. The second computing device 104 may be operated by an unauthorized user. The unauthorized user may include, but is not limited to, an attacker, a malicious user, a malicious attacker, an intruder, an unauthorized person, bad actors, threat actors, cyber threat actors (CTA), and malicious actors, cybercriminals, hacktivists, insiders, cyberterrorists, hackers and the like.

The pulse intrusion detection module 116 may be configured to refuse the unauthorized user attempts to access in-process communications, data or content they do not have permission to view. The content may include, but is not limited to, a static piece of content, dynamic content, and the like. The static content may include, but is not limited to, pictures, photos, images, text documents, pdf documents, word documents, executable programs, data payloads, and the like. The dynamic content may include, but is not limited to, live videos, recorded videos, sound, video conferences, interactive media, video games, and the like. The in-process communications may include, but is not limited to, video calling, voice calling, data sharing, content sharing, multimedia sharing, and the like.

The pulse intrusion detection module 116 may be configured re-direct the unauthorized user to the safe zone upon identifying the digital intrusion and enables the pulse intrusion detection module 116 to spoof an authentication process to aggregate additional intelligence from the unauthorized user about their intent, and their origin. The safe zone may include, but is not limited to, a safe walled virtual environment, a reverse phishing area, walled-off zone, an isolated area, a safe-walled zone, and the like. The additional intelligence may include, but is not limited to, an e-mail, a phone number, a mac address, a UUID, an IP address, false security questions, and compares to the valid user database, threat information, and the unauthorized user identity to try and better understand whom the unauthorized user is trying to impersonate, what the unauthorized user is trying to accomplish, what data the unauthorized user is attempting to steal, Web-form questions such as please input your email address so we can mail you a password, or please input your phone number, will give system forensic endpoints to investigate, Who they are attempting to falsely authenticate as, may give forensic data to help define where security leakages are occurring, based on user practices, or for which departments outsiders are trying to steal information.

The pulse intrusion detection module 116 may be configured to deliver data prompts when the unauthorized user is in the safe cone and enables the unauthorized user to provide input which may help to identify, who they are attempting to impersonate, what they are trying to steal, or what malicious activity they try to perform, and the like. The data-prompts may work as a typical phishing attack but in reverse, where the pulse intrusion detection module 116 is eliciting (extracting) responses from the unauthorized user for use in the forensic analysis.

The pulse intrusion detection module 116 may be configured to detect digital intrusion at an injection of the pulse into the content, an unauthorized attempt performed by the unauthorized user to read a pulse-protected document, and an unauthorized attempt performed by the unauthorized user to login into a pulse-protected communication (in-progress communications). The pulse may include, but is not limited to, micro pulse, PowerPulse, dynamic pulse, and the like. The pulse-protected communication may include, but is not limited to, sharing content, video conferencing, voice calling, sending texts, sending emails, posting social media content, sharing pictures, bits, bytes, and the like. The pulse-protected document may include, but is not limited to, passports, driver's licenses, birth certificates, vaccination certificates, and the like.

The pulse codes may include structures, multiple pulse layers, and the like. The multiple pulse layers may include, but not limited to, Pulse Capsule, Power Pulse Encryption—Key (256-bit)—The key that encrypts the data inside the Pulse, Micro Pulse—Who (ie. user names, private keys, passwords, mac address, cookie), Micro Pulse—What (i.e. application, data type, session password), Micro Pulse—How (wireless, wireline, public wifi, LAN, WAN, VPN), Micro Pulse—Where (GPS, zip codes), Micro Pulse—Why (public, private, authentication, certification, static, dynamic), Micro Pulse—When(TimeStamps), Micro Pulse—Index(link to other databases), Micro Pulse—Logic (Parameters of Micro Pulse Interactions) (Un/Acceptable combinations of Layers,) and the like. The external database 110a may be configured to store weather information, social media feeds, weather feeds, stock feeds, location based services, news feeds, event feeds, product data, classified feeds, IoT feeds, customer feeds, supplier feeds, restful data, webstocks, and the like. The internal database 110b may be configured to store user's information, user's roles, security levels, and the like. The cloud server 108 includes the pulse intrusion detection module 116.

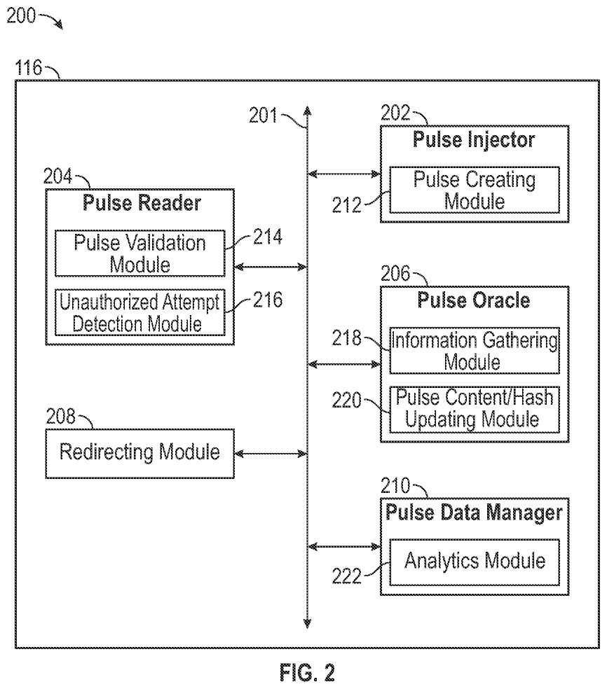

Referring to FIG. 2 is a block diagram 200 depicting an embodiment of the pulse intrusion detection module 116, in accordance with one or more exemplary embodiments. The block diagram 200 includes a bus 201, a pulse injector 202, a pulse reader 204, a pulse oracle 206, a redirecting module 208, and a pulse data manager 210. The pulse injector 202 includes a pulse-creating module 212. The pulse reader includes a pulse validation module 214, and an unauthorized attempt detection module 216. The pulse oracle 206 includes an information-gathering module 218, and a pulse content/hash updating module 220. The pulse data manager 210 includes an analytics module 222.

The bus may include a path that permits communication among the modules of the pulse intrusion detection module 116 installed on the first computing device 102 and the cloud server 108. The term “module” is used broadly herein and refers generally to a program resident in the memory of the first computing device 102 and the cloud server 108. The pulse injector 202 may be configured to inject the pulse into the content. The content may include, but is not limited to, a static piece of content, dynamic content, and the like. The static content may include, but is not limited to, pictures, photos, images, text documents, pdf documents, word documents, executable programs, data payloads, and the like. The dynamic content may include, but is not limited to, live videos, recorded videos, sound, video conferences, interactive media, video games, and the like. The pulse-creating module 212 may be configured to construct a set of micro pulses and their corresponding values to create a pulse. The pulse injector 202 may remain in synchronization with the pulse reader 204 and is configured to identify whether the unauthorized user attempts to inject pulse into the content. If the values provided in the micro-pulse are valid then the user is said to be the valid user. If the values provided in the micro-pulse are not valid, and/or are values that are on a bad actor/threat list, then the user is said to be the unauthorized user and the unauthorized user is re-directed to the isolated, reverse-phishing area to gather the additional intelligence.

The pulse injector 202 may be configured to submit the set of micro pulses to the outgoing communications, and the pulse reader 204 may be configured to validate the incoming communications. The valid pulse targets for each user may be contextual to each user, so any outside attacker will need to try and spoof their credentials and embed them continuously into the communication, at the same synchronization pattern as the oracle is expecting.

In accordance with one or more exemplary embodiments of the present disclosure, the pulse reader 204 may be configured to identify the valid user or the unauthorized user attempts to read the pulse from the pulse-protected content/the pulse-protected document/and the pulse-protected communication. The pulse reader 204 includes the pulse validation module 214 may be configured to validate the pulse of the valid user and/or the unauthorized user attempts to access the pulse-protected content/the pulse-protected document/and the pulse-protected communication. The pulse reader 204 may be configured to determine the set of micro pulses and corresponding values injected into the pulse-protected content, the pulse-protected document, and the pulse-protected communication is valid; and whether the set of micro pulses and corresponding values are on a bad actor/threat list.

In accordance with one or more exemplary embodiments of the present disclosure, the pulse reader 204 includes the unauthorized attempt detection module 216 may be configured to provide neutral feedback once it considers an attempt deemed to be malicious. The unauthorized attempt detection module 216 may be configured to identify the digital intrusion of the unauthorized user during the in-process communication between the first computing device 102 and the third computing device 105. The unauthorized attempt detection module 216 may be configured to re-direct the unauthorized user to the safe zone for collecting/gathering the forensic data about the unauthorized user and their intent, origin. The unauthorized attempt detection module 216 may be configured to portray the unauthorized user that a password entered is wrong, and requests to try again.

The pulse reader 204 may be configured to determine whether the micro-pulse values are valid, and what information the valid user may have access in the pulse content/pulse-protected document. If the micro-pulse values are not valid and/or are values that are on a bad actor/threat list, the malicious user (unauthorized user) may be re-directed to the isolated, reverse-phishing area to gather the additional intelligence.

The pulse injector 202, and the pulse reader 204 may be configured to identify the attempt of the unauthorized user (malicious attacker) trying to join the pulse-protected communication. The pulse-protected communication may include, but is not limited to, sharing content, video conferencing, voice calling, sending texts, sending emails, posting social media content, sharing pictures, bits, bytes, and the like.

The pulse oracle 206, the pulse reader 204, or the pulse injector 202 may be configured to re-direct the unauthorized user to the isolated, reverse-phishing area to gather the additional intelligence upon identifying duplicate attempts or multiple failed attempts to provide authentication elements (i.e. 256 bit, session key). Additionally, once the unauthorized user is identified, all the data may be logged, and new micro pulse targets may be distributed to the pulse injector 202 and the pulse reader 204, to prevent any progress made by the unauthorized user. In addition, the pulse oracle 206 may be configured to continue to rotate these micro pulse values to continuously remove the progress of any brute-force (continuously guessing) attacks. The pulse oracle 206 may be configured to dynamically change the pulse content/hash in real-time for any in-process communications to prevent quantum-level attacks, without any impact on the quality of the in-process communications.

The pulse oracle 206 includes the information-gathering module 218 may be configured to request additional intelligence from the unauthorized user to keep alive the connection between the first computing device 102 and the second computing device 104 upon identifying the digital intrusion. The additional intelligence may include, but is not limited to, the unauthorized user identity to try and better understand who they are trying to impersonate, what they are trying to accomplish, what data they are attempting to steal, and the like, Web-form questions such as please input your email address so we can mail you a password, or please input your phone number, provides system forensic endpoints to investigate, Who they are attempting to falsely authenticate as, provides forensic data to help define where security leakages are occurring, based on user practices, or for which departments outsiders are trying to steal information.

In accordance with one or more exemplary embodiments of the present disclosure, the pulse oracle 206 includes the pulse content/hash updating module 220 may be configured to dynamically change the pulse content/hash in real-time for any in-process communications to prevent quantum-level attacks, without any impact on the quality of the in-process communications. Once the in-process communication or the pulsed document is identified at-risk, the pulse oracle 204 through its synchronization with the pulse-reader 206, and the pulse-injector 202 may programmatically and continuously change the micro-pulse values to eliminate the value of brute-force attacks, and generate forensic evidence about what users, data, and communications are at risk.

The redirecting module 208 may be configured to re-direct the unauthorized user to the safe zone intended to perform forensic analysis on the unauthorized user's origins and intent. The internet protocol addresses may be compared to online threat databases, and country of origin may be compared to recent-attack originations.

In accordance with one or more exemplary embodiments of the present disclosure, the pulse data manager 210 includes the analytics module 222 may be configured to perform analytics to try and identify additional intelligence about the unauthorized user. The analytics module 218 may be configured to compare internet protocol to a bad actors list, compare region of origination vs region of the bad actors list, Check OTRP database of attacks, Watch for base64 encoding (malware), Log information about who is trying to authenticate as, Log information about from which area the unauthorized user trying to get access to, Direct to reverse-phishing form to gather additional intelligence. The additional intelligence may include, but not limited to, E-mail, phone number, false security questions, and compare to the valid user database.

The pulse injector 202 may be synchronized with the pulse reader 204, and the pulse oracle 206 embedded in the cloud server 108 configured to programmatically and continuously change micro pulse values to eliminate the value of brute-force attacks, and generate forensic evidence about what users, data, and communications are at risk. The pulse injector 202 may be synchronized with the pulse reader 204, and the pulse oracle 206 embedded in the cloud server 108 configured to redirect the unauthorized user to the firewalled safe zone (isolated, reverse-phishing area, safe zone) to gather the additional intelligence upon identifying duplicate attempts, malicious activities or multiple failed attempts to provide authentication elements (i.e. 256 bit session key).

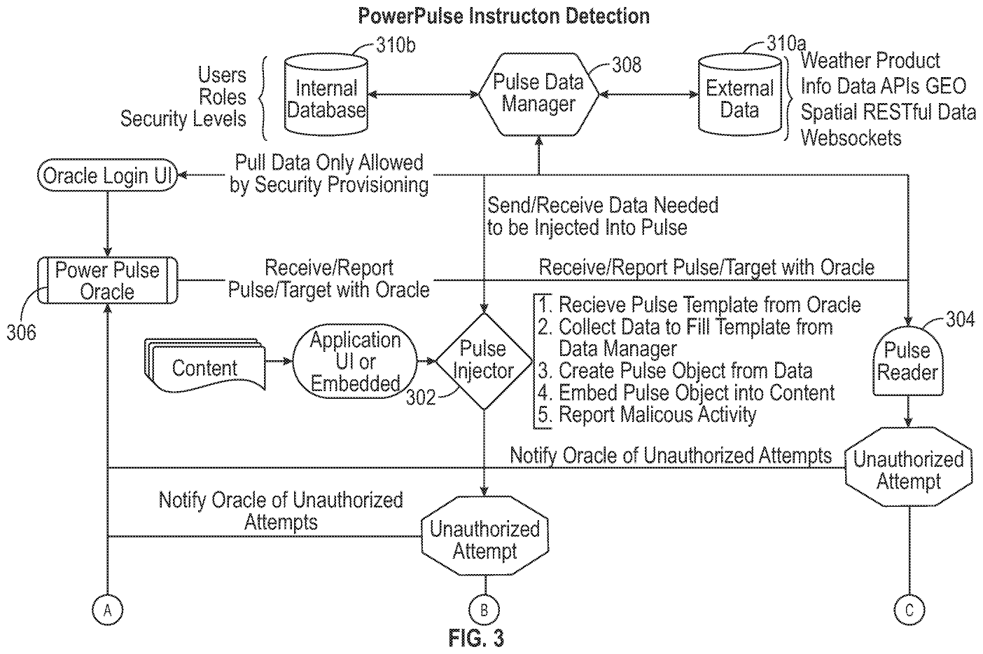

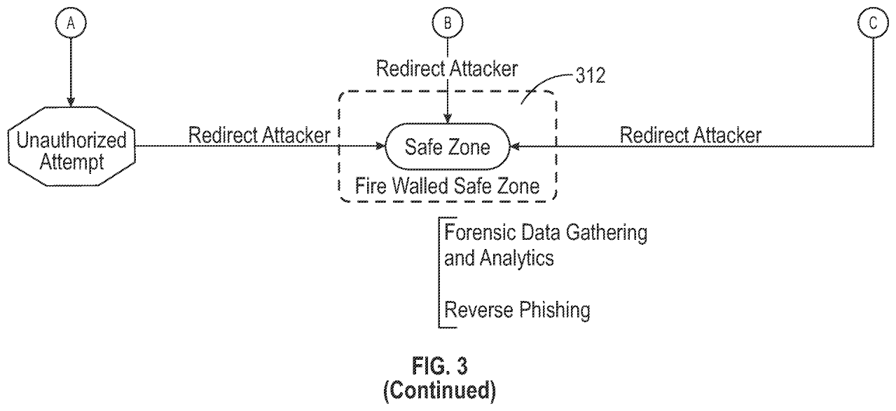

Referring to FIG. 3 is a block diagram 300 depicting an embodiment of the digital intrusion detection, in accordance with one or more exemplary embodiments. The diagram 300 includes a pulse injector 302, the pulse reader 304, the pulse oracle 306, the pulse data manager 308, the external database 310a, an internal database 310b, and a firewalled safe zone 312.

The pulse injector 302 may be configured to submit the set of micro pulses and corresponding values to the outgoing communications, and the pulse reader 304 may be configured to validate the incoming communications. The pulse oracle 306 may be configured to dynamically change the pulse content/hash in real-time for any in-process communications to prevent quantum-level attacks, without any impact on the quality of the in-process communications. The pulse injector 302 may remain in synchronization with the pulse oracle 306 and is configured to identify whether the unauthorized user attempts to inject pulse into the content. The pulse oracle 306, the pulse reader 304, or the pulse injector 302 may be configured to re-direct the unauthorized user to the firewalled safe zone 312 (isolated, reverse-phishing area, safe zone) to gather the additional intelligence upon identifying duplicate attempts, malicious activities or multiple failed attempts to provide authentication elements (i.e. 256 bit session key).

The pulse injector 302 may be configured receive pulse template from the pulse oracle 306, collect data to fill template from the pulse data manager 308, creates the pulse object from the data, embed the pulse object into the content, and reports malicious activity.

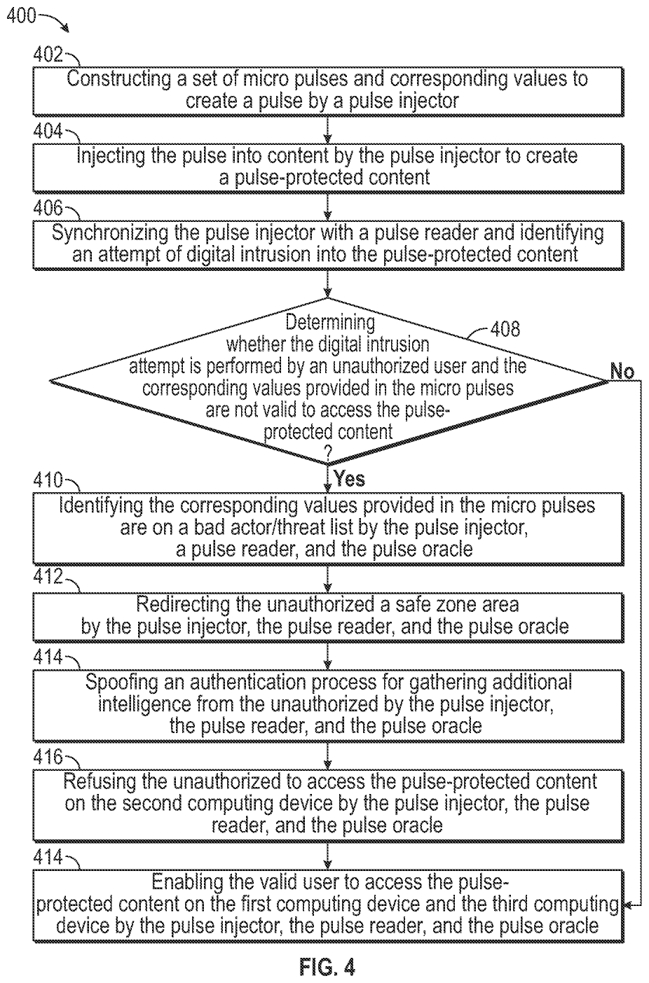

Referring to FIG. 4 is a flow diagram 400 depicting a method for detecting digital intrusion at the injection of the pulse into the content, in accordance with one or more exemplary embodiments. The method 400 may be carried out in the context of the details of FIG. 1A, FIG. 1B, FIG. 2, FIG. 3. However, the method 400 may also be carried out in any desired environment. Further, the aforementioned definitions may equally apply to the description below.

The method commences at step 402, constructing the set of micro pulses and their corresponding values to create the pulse by the pulse injector. Thereafter at step 404, injecting the pulse into the content by the pulse injector to create the pulse-protected content. Thereafter at step 406, synchronizing the pulse reader with the pulse injector and identifying the attempt of digital intrusion in the pulse content. Determining whether the digital intrusion attempt is performed by the unauthorized user and the corresponding values provided in the micro-pulse are not valid to access the pulse content? at step 408. If the answer to step 408 is Yes, the method continues at step 410, identifying the corresponding values provided in the micro pulses are on the bad actor/threat list by the pulse injector, the pulse reader, and the pulse oracle. Thereafter at step 412, redirecting the unauthorized user to the safe zone by the pulse injector, the pulse reader, and the pulse oracle. Thereafter at step 414, spoofing the authentication process for gathering additional intelligence from the unauthorized user by the pulse injector, the pulse reader, and the pulse oracle. Thereafter at step 416, refusing the unauthorized user to access the pulse content by the pulse injector, the pulse reader, and the pulse oracle. If the answer to step 408 is No, the method continues at step 418, enabling the valid user to access the pulse content by the pulse injector, the pulse reader, and the pulse oracle.

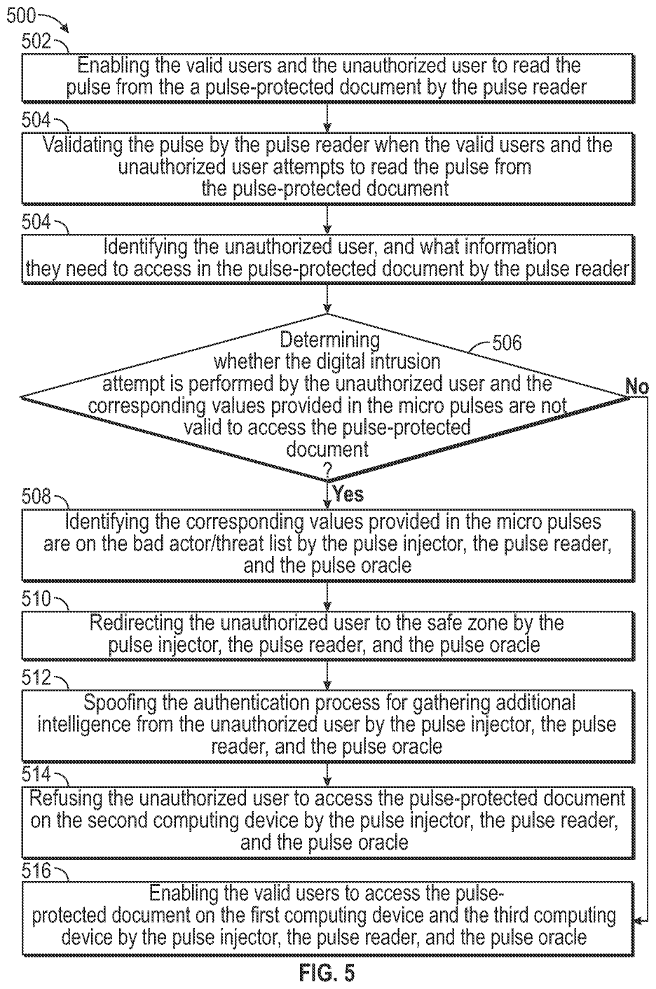

Referring to FIG. 5 is a flow diagram 500 depicting a method for detecting an unauthorized attempt to read the pulse-protected document, in accordance with one or more exemplary embodiments. The method 500 may be carried out in the context of the details of FIG. 1, FIG. 2, FIG. 3, and FIG. 4. However, the method 500 may also be carried out in any desired environment. Further, the aforementioned definitions may equally apply to the description below.

The method commences at step 502, enabling the valid users and the unauthorized users to read the pulse from the pulse-protected document by the pulse reader. Thereafter at step 504, validating the pulse by the pulse reader when the valid users and the unauthorized user attempts to read the pulse from the pulse-protected document. Thereafter at step 504, identifying the unauthorized user, and what intelligence/information they need to access in the pulse-protected document. Determining whether the digital intrusion attempt is performed by the unauthorized user and the corresponding values provided in the micro pulses are not valid to access the pulse-protected document? at step 506. If the answer to step 506, is yes, the method continues at step 508, identifying the corresponding values provided in the micro pulses are on the bad actor/threat list by the pulse injector, the pulse reader, and the pulse oracle. Thereafter at step 510, redirecting the unauthorized user to the safe zone by the pulse injector, the pulse reader, and the pulse oracle. Thereafter at step 512, spoofing the authentication process for gathering additional intelligence from the unauthorized user. Thereafter at step 514, refusing the unauthorized user to access the pulse-protected document on the second computing device by the pulse injector, the pulse reader, the pulse oracle. If the answer to step 506 is No, the method continues at step 516, enabling the valid users to access the pulse-protected document on the first computing device and the third computing device by the pulse injector, the pulse reader, and the pulse oracle.

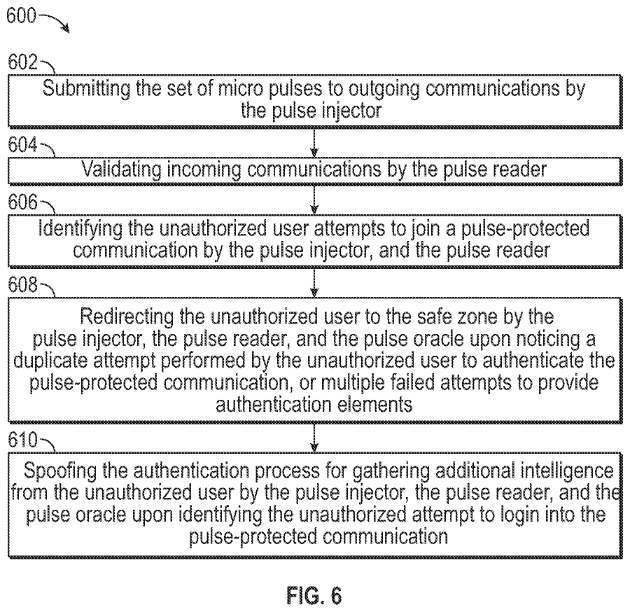

Referring to FIG. 6 is a flow diagram 600 depicting a method for detecting an unauthorized attempt to login into the pulse-protected communication, in accordance with one or more exemplary embodiments. The method 600 may be carried out in the context of the details of FIG. 1, FIG. 2, FIG. 3, FIG. 4, and FIG. 5. However, the method 600 may also be carried out in any desired environment. Further, the aforementioned definitions may equally apply to the description below.

The method commences at step 602, submitting the set of micro pulses to outgoing communications by the pulse injector. Thereafter at step 604, validating incoming communications by the pulse reader. Thereafter at step 606, identifying the unauthorized user attempts to join a pulse-protected communication, by the pulse injector, and the pulse reader. Thereafter at step 608, redirecting the unauthorized user to the safe zone by the pulse injector, the pulse reader, and the pulse oracle upon noticing the duplicate attempts to authenticate the pulse-protected communication, or multiple failed attempts to provide authentication elements. Thereafter at step 610, spoofing the authentication process for gathering additional intelligence from the unauthorized user by the pulse injector, the pulse reader, and the pulse oracle upon identifying the unauthorized attempt to login into the pulse-protected communication.

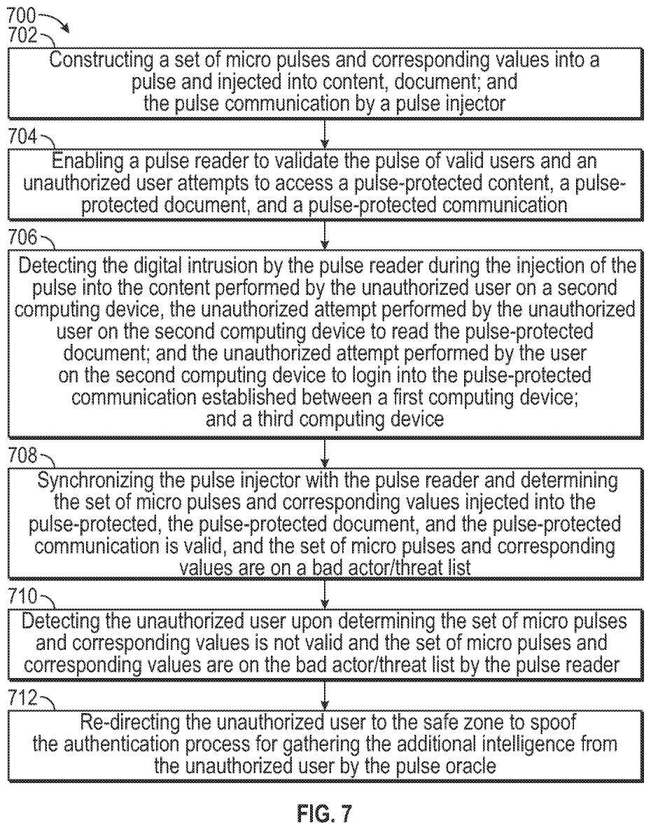

Referring to FIG. 7 is a flow diagram 700 depicting a method for detecting digital intrusion and redirecting to safe zone to spoof authentication process in real-time, in accordance with one or more exemplary embodiments. The method 700 may be carried out in the context of the details of FIG. 1, FIG. 2, FIG. 3, FIG. 4, FIG. 5, and FIG. 6. However, the method 700 may also be carried out in any desired environment. Further, the aforementioned definitions may equally apply to the description below.

The method commences at step 702, constructing the set of micro pulses and corresponding values into the pulse and the pulse is injected into the content, the document; and communication by a pulse injector. Thereafter at step 704, enabling the pulse reader to validate the pulse of valid users and the unauthorized user attempts to access the pulse-protected content, the pulse-protected document, and the pulse-protected communication. Thereafter at step 706, detecting the digital intrusion by the pulse reader during the injection of the pulse into the content by the unauthorized user on the second computing device; the unauthorized attempt performed by the unauthorized user on the second computing device to read the pulse-protected document and the unauthorized attempt performed by the unauthorized user on the second computing device to login into the pulse-protected communication established between the first computing device; and the third computing device. Thereafter at step 708, synchronizing the pulse reader with the pulse injector and determining the set of micro pulses and corresponding values injected into the pulse content, the pulse-protected document; and the pulse-protected communication are valid; and the set of micro pulses and corresponding values are on a bad actor/threat list. Thereafter at step 710, detecting the unauthorized user upon determining the set of micro pulses and corresponding values are not valid and the set of micro pulses and corresponding values are on the bad actor/threat list by the pulse reader. Thereafter at step 712, re-directing the unauthorized user to the safe zone to spoof the authentication for gathering the additional intelligence from the unauthorized user by the pulse oracle.

Referring to FIG. 8 is a block diagram 800 illustrating the details of a digital processing system 800 in which various aspects of the present disclosure are operative by execution of appropriate software instructions. The Digital processing system 800 may correspond to the first computing device 102, the second computing device 104 or the third computing device 105 (or any other system in which the various features disclosed above can be implemented).

Digital processing system 800 may contain one or more processors such as a central processing unit (CPU) 810, random access memory (RAM) 820, secondary memory 830, graphics controller 860, display unit 870, network interface 880, and input interface 890. All the components except display unit 870 may communicate with each other over communication path 850, which may contain several buses as is well known in the relevant arts. The components of FIG. 8 are described below in further detail.

CPU 810 may execute instructions stored in RAM 820 to provide several features of the present disclosure. CPU 810 may contain multiple processing units, with each processing unit potentially being designed for a specific task. Alternatively, CPU 810 may contain only a single general-purpose processing unit. CPU 810 may be a physical processor or a virtual processor with a virtual machine or containerized system.

RAM 820 may receive instructions from secondary memory 830 using communication path 850. RAM 820 is shown currently containing software instructions, such as those used in threads and stacks, constituting shared environment 825 and/or user programs 826. Shared environment 825 includes operating systems, device drivers, virtual machines, etc., which provide a (common) run time environment for execution of user programs 826. RAM 820 may be a physical component or a virtual component within a virtual machine or containerized system such as a Docker.

Graphics controller 860 generates display signals (e.g., in RGB format) to display unit 870 based on data/instructions received from CPU 810. Display unit 870 contains a display screen to display the images defined by the display signals. Input interface 890 may correspond to a keyboard and a pointing device (e.g., touch-pad, mouse) and may be used to provide inputs. Network interface 880 provides connectivity to a network (e.g., using Internet Protocol), and may be used to communicate with other systems (such as those shown in FIG. 1) connected to the network 106. Graphics controller 860 may be a physical component or a virtual component within a virtual machine or containerized system such as Docker.

Secondary memory 830 may contain hard drive 835, flash memory 836, and removable storage drive 837. Secondary memory 830 may store the data software instructions (e.g., for performing the actions noted above with respect to the Figures), which enables digital processing system 800 to provide several features in accordance with the present disclosure. Secondary memory 830 may be a physical component or a virtual component within a virtual machine or containerized system such as Docker.

Some or all of the data and instructions may be provided on removable storage unit 840, and the data and instructions may be read and provided by removable storage drive 837 to CPU 810. Floppy drive, magnetic tape drive, CD-ROM drive, DVD Drive, Flash memory, removable memory chip (PCMCIA Card, EEPROM) are examples of such removable storage drive 837.

Removable storage unit 840 may be implemented using medium and storage format compatible with removable storage drive 837 such that removable storage drive 837 can read the data and instructions. Thus, removable storage unit 840 includes a computer readable (storage) medium having stored therein computer software and/or data. However, the computer (or machine, in general) readable medium can be in other forms (e.g., non-removable, random access, etc.).

In this document, the term “computer program product” is used to generally refer to removable storage unit 840 or hard disk installed in hard drive 835. These computer program products are means for providing software to digital processing system 800. CPU 810 may retrieve the software instructions, and execute the instructions to provide various features of the present disclosure described above.

The term “storage media/medium” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage memory 830. Volatile media includes dynamic memory, such as RAM 820. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus (communication path) 850. Transmission media can also take the form of acoustic or light waves, such as those generated during radio-wave and infra-red data communications.

Reference throughout this specification to “one embodiment”, “an embodiment”, or similar language means that a particular feature, structure, or characteristic described in connection with the embodiment is included in at least one embodiment of the present disclosure. Thus, appearances of the phrases “in one embodiment”, “in an embodiment” and similar language throughout this specification may, but do not necessarily, all refer to the same embodiment.

Furthermore, the described features, structures, or characteristics of the disclosure may be combined in any suitable manner in one or more embodiments. In the above description, numerous specific details are provided such as examples of programming, software modules, user selections, network transactions, database queries, database structures, hardware modules, hardware circuits, hardware chips, etc., to provide a thorough understanding of embodiments of the disclosure.

Although the present disclosure has been described in terms of certain preferred embodiments and illustrations thereof, other embodiments and modifications to preferred embodiments may be possible that are within the principles and spirit of the invention. The above descriptions and figures are therefore to be regarded as illustrative and not restrictive.

Thus the scope of the present disclosure is defined by the appended claims and includes both combinations and sub-combinations of the various features described hereinabove as well as variations and modifications thereof, which would occur to persons skilled in the art upon reading the foregoing description.

According to an exemplary aspect of the present disclosure, a system for detecting digital intrusion in real-time and redirecting to a safe zone, includes a first computing device 102 and a third computing device 105 includes a processor 112, a memory 114 and a pulse intrusion detection module 116, the processor 112 coupled with the memory 114 configured to store a pulse intrusion detection module 116.

According to another exemplary aspect of the present disclosure, the pulse intrusion detection module 116 includes a pulse injector 202, a pulse reader 204, a pulse oracle 206, and a pulse data manager 208, the pulse injector 202 configured to construct a set of micro pulses and corresponding values into a pulse and the pulse is injected into at least one of: content; document; and communication thereby creating at least one of: a pulse protected content; a pulse-protected document; and a pulse-protected communication.

According to another exemplary aspect of the present disclosure, the pulse reader 204 configured to remain in synchronization with the pulse injector 202, the pulse reader 204 configured to validate the pulse of at least one of: a valid user; and an unauthorized user; attempts to access at least one of: the pulse-protected content; the pulse-protected document; and the pulse-protected communication; and detect digital intrusion during at least one of: an injection of the pulse into the content by the unauthorized user on the second computing device; an unauthorized attempt by the unauthorized user on the second computing device 104 to read the pulse-protected document located on the at least of: the first computing device 102; and the third computing device 105; and the unauthorized attempt by the unauthorized user on the second computing device 104 to login into the pulse-protected communication established between the first computing device 102; and the third computing device 105.

According to another exemplary aspect of the present disclosure, the pulse reader 204 is configured to determine at least one of: the set of micro pulses and corresponding values injected into at least one of: the pulse-protected content; the pulse-protected document; and the pulse-protected communication are valid; and the set of micro pulses and corresponding values are on a bad actor/threat list. The pulse reader 204 configured to detect the unauthorized user on the second computing device 104 trying to attempt to access at least one of: the pulse-protected content; the pulse-protected document; and the pulse-protected communication; upon determining the set of micro pulses and corresponding values are not valid and the set of micro pulses and corresponding values are on the bad actor/threat list.

According to another exemplary aspect of the present disclosure, the pulse oracle 206 through its synchronization with the pulse-reader 204, and the pulse-injector 202 configured to change the set of micro pulses and corresponding values continuously and programmatically to mitigate and eliminate the value of brute-force attacks, and to generate and archive forensic evidence about at least one of: the pulse-protected content; the pulse-protected document; and the pulse-protected communication upon identifying at least one of: the pulse-protected content; the pulse-protected document and the pulse-protected communication are at risk. The pulse oracle 206 configured to re-direct the unauthorized user to a safe zone to spoof the authentication process for gathering additional intelligence and refuses to access at least one of: the pulse-protected content; the pulse-protected document; and the pulse-protected communication.

According to another exemplary aspect of the present disclosure, the pulse injector includes the pulse creating module 212 is configured to submit the set of micro pulses to one or more outgoing communications. The pulse reader 204 includes the pulse validation module 214 is configured to validate one or more incoming communications. The pulse reader 204 includes the unauthorized attempt detection module 216 is configured to provide neutral feedback upon considering an attempt deemed to be malicious. The unauthorized attempt detection module 216 is configured to identify the digital intrusion attempt performed by the unauthorized user on the second computing device 104 during the in-process communication between the first computing device 102 and the third computing device 105.

According to another exemplary aspect of the present disclosure, the unauthorized attempt detection module 216 is configured to re-direct the unauthorized user on the second computing device 104 to the safe zone for gathering forensic data, intent, and origin. The unauthorized attempt detection module 216 is configured to portray the unauthorized user that a password entered is wrong, and requests to try again. The pulse oracle 206 is configured to log all the data and distributes new set of micro pulse targets to the pulse injector 202 and the pulse reader 204 upon identifying the unauthorized user thereby preventing any progress made by the unauthorized user.

According to another exemplary aspect of the present disclosure, the pulse oracle 206 is configured to continue to rotate the set of micro pulses and the corresponding values to continuously remove the progress of any brute-force (continuously guessing) attacks. The pulse oracle 206 is configured to dynamically change the pulse content/hash in real-time for any in-process communications to prevent quantum-level attacks, without any impact on the quality of the in-process communications. The pulse oracle 206 is configured to remain in synchronization with the pulse injector 202, the pulse oracle 206 is configured to validate the pulse of at least one of: the valid user; and the unauthorized user; attempts to access at least one of: the pulse-protected content; the pulse-protected document; and the pulse-protected communication.

According to another exemplary aspect of the present disclosure, the pulse oracle 206 includes the information-gathering module 218 is configured to request the additional intelligence from the unauthorized user to keep alive the connection between at least one of: the valid user and the unauthorized user; upon identifying the digital intrusion. The pulse content/hash updating module 220 is configured to dynamically change the pulse content/hash in real-time for any in-process communications to prevent quantum-level attacks, without any impact on the quality of the in-process communications.

According to another exemplary aspect of the present disclosure, the redirecting module 208 is configured to re-direct the unauthorized user on the second computing device 104 to a virtual environment (reverse-phishing area) intended to run forensic analysis on the unauthorized user origins and intent. The analytics module 222 is configured to perform analytics to try and identify the additional intelligence about the unauthorized user. The analytics module 222 is configured to compare internet protocol to a bad actors list, compare region of origin vs region of the bad actors list, check online transaction processing database of attacks, watch for base64 encoding (malware), log information about who is trying to authenticate as, log information about from which area the unauthorized user trying to get access to, direct to the safe zone to gather additional intelligence.

What is claimed is:

1. A system for detecting digital intrusion in real-time and redirecting to a safe zone, comprising:
a first computing device and a third computing device comprising a processor, a memory and a pulse intrusion detection module, wherein the processor coupled with the memory configured to store a digital intrusion detection module;
the pulse intrusion detection module comprises a pulse injector, a pulse reader, a pulse oracle, and a pulse data manager, whereby the pulse injector configured to construct a set of micro pulses and corresponding values into a pulse and the pulse is injected into at least one of: content; document; and communication thereby creating at least one of: a pulse protected content; a pulse-protected document; and a pulse-protected communication;
the pulse reader configured to remain in synchronization with the pulse injector, the pulse reader configured to validate the pulse of at least one of: a valid user; and an unauthorized user; attempts to access at least one of: the pulse-protected content; the pulse-protected document; and the pulse-protected communication; and detects digital intrusion during at least one of: an injection of the pulse into the content by the unauthorized user on the second computing device; an unauthorized attempt by the unauthorized user on the second computing device to read the pulse-protected document located on the at least of: the first computing device; and the third computing device; and the unauthorized attempt by the unauthorized user on the second computing device to login into the pulse-protected communication established between the first computing device; and the third computing device;
the pulse reader is configured to determine at least one of: the set of micro pulses and corresponding values injected into at least one of: the pulse-protected content; the pulse-protected document; and the pulse-protected communication are valid; and the set of micro pulses and corresponding values are on a bad actor/threat list, whereby the pulse reader configured to detect the unauthorized user on the second computing device trying to attempt to access at least one of: the pulse-protected content; the pulse-protected document; and the pulse-protected communication; upon determining the set of micro pulses and corresponding values are not valid and the set of micro pulses and corresponding values are on the bad actor/threat list;
the pulse oracle through its synchronization with the pulse-reader, and the pulse oracle configured to change the set of micro pulses and corresponding values continuously and programmatically to eliminate the value of brute-force attacks, and to generate forensic evidence about at least one of: the pulse-protected content; the pulse-protected document; and the pulse-protected communication upon identifying at least one of: the pulse-protected content; the pulse-protected document and the pulse-protected communication are at risk; and
the pulse oracle configured to re-direct the unauthorized user to a safe zone to spoof the authentication for gathering additional intelligence and refuses to access at least one of: the pulse-protected content; the pulse-protected document; and the pulse-protected communication.

2. The system of claim 1, wherein the pulse injector comprising a pulse creating module is configured to submit the set of micro pulses to one or more outgoing communications.

3. The system of claim 1, wherein the pulse reader comprising a pulse validation module is configured to validate one or more incoming communications.

4. The system of claim 1, wherein the pulse reader comprising an unauthorized attempt detection module is configured to provide neutral feedback upon considering an attempt deemed to be malicious.

5. The system of claim 1, wherein the unauthorized attempt detection module is configured to identify the digital intrusion attempt performed by the unauthorized user on the second computing device during the in-process communication between the first computing device and the third computing device.

6. The system of claim 1, wherein the unauthorized attempt detection module is configured to re-direct the unauthorized user on the second computing device to the safe zone for gathering forensic data, intent, and origin.

7. The system of claim 1, wherein the unauthorized attempt detection module is configured to portray the unauthorized user that a password entered is wrong, and requests to try again.

8. The system of claim 1, wherein the pulse oracle is configured to log all the data and distributes new set of micro pulse targets to the pulse injector and the pulse reader upon identifying the unauthorized user thereby preventing any progress made by the unauthorized user.

9. The system of claim 1, wherein the pulse oracle is configured to continue to rotate the set of micro pulses and the corresponding values to continuously remove the progress of any brute-force (continuously guessing) attacks.

10. The system of claim 1, wherein the pulse oracle is configured to dynamically change the pulse content/hash in real-time for any in-process communications to prevent quantum-level attacks, without any impact on the quality of the in-process communications.

11. The system of claim 1, wherein the pulse oracle is configured to remain in synchronization with the pulse injector, whereby the pulse oracle is configured to validate the pulse of at least one of: the valid user; and the unauthorized user; attempts to access at least one of: the pulse-protected content; the pulse-protected document; and the pulse-protected communication.

12. The system of claim 1, wherein the pulse oracle comprising an information-gathering module is configured to request the additional intelligence from the unauthorized user to keep alive the connection between at least one of: the valid user and the unauthorized user; upon identifying the digital intrusion.

13. The system of claim 1, wherein the pulse oracle comprising a pulse content/hash updating module is configured to dynamically change the pulse content/hash in real-time for any in-process communications to prevent quantum-level attacks, without any impact on the quality of the in-process communications.

14. The system of claim 1, wherein the pulse intrusion detection module comprising a redirecting module is configured to re-direct the unauthorized user on the second computing device to a virtual environment (reverse-phishing area) intended to run forensic analysis on the unauthorized user origins and intent.

15. The system of claim 1, wherein the pulse intrusion detection module comprises an analytics module configured to perform analytics to try and identify the additional intelligence about the unauthorized user.

16. The system of claim 15, wherein the analytics module is configured to compare internet protocol to a bad actors list, compare region of origin vs region of the bad actors list, check online transaction processing database of attacks, watch for base64 encoding (malware), log information about who is trying to authenticate as, log information about from which area the unauthorized user trying to get access to, direct to the safe zone to gather additional intelligence.

17. A method for detecting digital intrusion and redirecting to reverse-phishing area to spoof authentication in real-time, comprising:
constructing a set of micro pulses and corresponding values into a pulse and is injected into at least one of: content, a document; and communication; to create a pulse-protected content; pulse-protected document; and a pulse-protected communication by a pulse injector;
enabling a pulse reader to validate the pulse of at least one of: a valid user; and an unauthorized user; attempting to access at least one of: the pulse-protected content; the pulse-protected document; and the pulse-protected communication;
synchronizing the pulse injector with the pulse reader and detecting digital intrusion during at least one of: an injection of the pulse into the content by the unauthorized user on the second computing device; an unauthorized attempt performed by the unauthorized user on the second computing device to read the pulse-protected document of the at least of: the first computing device; and the third computing device; and an unauthorized attempt performed by the unauthorized user on the second computing device to login into the pulse-protected communication established between the first computing device; and the third computing device;
determining at least one of: the set of micro pulses and corresponding values injected into at least one of: the pulse content, the pulse-protected document; and the pulse-protected communication are valid; and the set of micro pulses and corresponding values are on a bad actor/threat list; by the pulse reader and
detecting the unauthorized user by the pulse reader upon determining the set of micro pulses and corresponding values are not valid and the set of micro pulses and corresponding values are on the bad actor/threat list;
synchronizing the pulse oracle with the pulse-reader, and the pulse oracle and changing the set of micro pulses and corresponding values continuously and programmatically to mitigate and eliminate the value of brute-force attacks;
generating and archiving forensic evidence about at least one of: the pulse-protected content; the pulse-protected document; and the pulse-protected communication upon identifying at least one of: the pulse-protected content; the pulse-protected document and the pulse-protected communication are at risk;
refusing the unauthorized user to access at least one of: the pulse-protected content; the pulse-protected document; and the pulse-protected communication by the pulse oracle; and
re-directing the unauthorized user to a safe zone to spoof the authentication process for gathering additional intelligence from the unauthorized user by the pulse oracle.

18. The method of claim 17, comprising a step submitting the set of micro pulses to one or more outgoing communications by a pulse creating module.

19. The method of claim 17, comprising a step of validating one or more incoming communications by a pulse validation module.

20. The method of claim 17, comprising a step of providing neutral feedback upon considering an attempt to be malicious by an unauthorized attempt detection module.

21. The method of claim 17, comprising a step of identifying the digital intrusion attempt performed by the unauthorized user on the second computing device during the in-process communication between the first computing device and the third computing device by the unauthorized attempt detection module.

22. The method of claim 17, comprising a step of re-directing the unauthorized user on the second computing device to the safe zone for gathering forensic data, intent, and origin by the unauthorized attempt detection module.

23. The method of claim 17, comprising a step of portraying the unauthorized user that a password entered is wrong, and requests to try again by the unauthorized attempt detection module.

24. The method of claim 17, comprising a step of logging all the data and distributing new set of micro pulse targets to the pulse injector and the pulse reader upon identifying the unauthorized user thereby preventing any progress made by the unauthorized user.

25. The method of claim 17, comprising a step of continuing to rotate the set of micro pulses and the corresponding values to continuously remove the progress of any brute-force (continuously guessing) attacks by the pulse oracle.

26. The method of claim 17, comprising a step of dynamically changing the pulse content/hash in real-time for any in-process communications to prevent quantum-level attacks, without any impact on the quality of the in-process communications by the pulse oracle.

27. The method of claim 17, comprising a step of validating the pulse of at least one of: the valid user; and the unauthorized user; attempting to access at least one of: the pulse-protected content; the pulse-protected document; and the pulse-protected communication by the pulse oracle.

28. The method of claim 17, comprising a step of requesting the additional intelligence from the unauthorized user by an information-gathering module to keep alive the connection between at least one of: the valid user and the unauthorized user; upon identifying the pulse intrusion.

29. The method of claim 17, comprising a step of dynamically changing the pulse content/hash in real-time for any in-process communications to prevent quantum-level attacks, without any impact on the quality of the in-process communications by a pulse content/hash updating module.

30. The method of claim 17, comprising a step of re-directing the unauthorized user on the second computing device to a virtual environment (reverse-phishing area) intended to run forensic analysis on the unauthorized user origins and intent by a redirecting module.

31. The method of claim 17, comprising a step of performing analytics to try and identify the additional intelligence about the unauthorized user by an analytics module.

32. The method of claim 17, comprising a step of comparing internet protocol to a bad actors list, comparing region of origin vs region of the bad actors list, checking online transaction processing database of attacks, watching for base64 encoding (malware), logging information about who is trying to authenticate as, logging information about from which area the unauthorized user trying to get access to, directing to safe zone to gather additional intelligence.
